(19) United States
(12) Patent Application Publication
(10) Pub. No.: US 2008/0013502 A1
(43) Pub. Date: Jan. 17, 2008

(54) WIRELESS DATA BUS

(76) Inventor: Alan R. Clark, Tucson, AZ (US)

Correspondence Address: WILMERHALE/BOSTON, 60 STATE STREET, BOSTON, MA, 02109, US

(21) Appl. No.: 11/672,700

(22) Filed: Feb. 8, 2007

Related U.S. Application Data
(60) Provisional application No. 60/771,534, filed on Feb. 8, 2006.
(60) Provisional application No. 60/811,952, filed on Jun. 8, 2006.

(51) Int. Cl. H04Q 7/24

(52) U.S. Cl. 370/338

(57) ABSTRACT

A wireless device for use with a plurality of wireless nodes that includes a controller node, the wireless device including a wireless transceiver for wirelessly communicating with the plurality of wireless nodes; a processor system; and memory storing a neighbor table, the memory also storing code which when executed on the processor causes the wireless device to initiate a discovery process during which the wireless device discovers neighbor nodes with which the wireless device establishes wireless communication links, identifies the discovered neighbor nodes in the neighbor table, and for each identified neighbor in the neighbor table indicates whether the corresponding link has an active status or a parked status, wherein the wireless device uses links having active status to send communications and does not use links having parked status to send communications.

This application claims the benefit of U.S. Provisional Application No. 60/771,534, filed Feb. 8, 2006, and U.S. Provisional Application No. 60/811,952, filed Jun. 8, 2006, both of which are incorporated herein by reference.

### TECHNICAL FIELD

This invention relates to a wireless network for communicating data to and from networked nodes that, for example, control the interior lights of an aircraft.

### BACKGROUND OF THE INVENTION

In commercial aircraft, there are lighting systems installed for purposes of illuminating the interior of the cabin, for providing reading lights for the passengers, for highlighting the aisles, and for providing emergency lighting. These systems are typically wired systems in which individual lighting units operate under the control of a central control computer on the plane. Because these systems are wired systems, they can be expensive to install and difficult to troubleshoot should any problems occur. Moreover, the great lengths of wire that are typically required to set up the control networks for these emergency lighting systems, especially on large commercial aircraft, can represent a significant weight load for the plane.

Obviously, it would be desirable to use wireless technology to implement these systems. However, setting up a wireless network within the interior of an airplane presents a special challenge. First, there are severe restrictions with regard to how much signal power can be used. The wireless signals are not supposed to extend outside the aircraft any significant distance so as to avoid interfering with other external wireless or RF systems. So power levels must be low. In addition, the environment inside the cabin of the aircraft can present serious problems because of how the movement of the passengers around the cabin, the delivery of food in the carts that are pushed up and down the aisles, and the carry-on bags in the overhead bins, just to name a few, produce obstacles to the wireless signals and interfere with reliable communications in the network.

The wireless network technology described herein addresses these problems.

### SUMMARY OF THE INVENTION

In general, in one aspect, the invention features a wireless device for use with a plurality of wireless nodes that includes a controller node. The wireless device includes: a wireless transceiver for wirelessly communicating with the plurality of wireless nodes; a processor system; and memory storing a neighbor table, the memory also storing code which when executed on the processor causes the wireless device to initiate a discovery process during which the wireless device discovers neighbor nodes with which the wireless device establishes wireless communication links, identifies the discovered neighbor nodes in the neighbor table, and for each identified neighbor in the neighbor table indicates whether the corresponding link has an active status or a parked status, wherein the wireless device uses links having active status to send communications and does not use links having parked status to send communications.

Other embodiments include one or more of the following features. The memory stores a measure of a distance that the wireless device is from the controller and wherein the code further causes the wireless device to send to each discovered neighbor node with which the wireless device establishes a wireless communications link information from its neighbor table as well as the measure of the distance of the wireless device from the controller, an identity of the wireless device, and a measure of the quality of the communications link with that discovered neighbor node. The code further causes the wireless device to receive information from the discovered neighbor nodes and store that received information in the neighbor table in association with the corresponding identified discovered nodes. The code further causes the wireless device to determine for which discovered neighbor nodes the corresponding links are to be identified as having active status and for which the corresponding links are to be identified as having parked status based at least in part on which discovered neighbor nodes provide better paths to the controller node. The code further causes the wireless device to determine for which discovered neighbor nodes the corresponding links are to be identified as having active status and for which the corresponding links are to be identified as having parked status based at least in part on how far the discovered nodes are from the controller, or based at least in part on the strength of signals received over the communications links to the discovered nodes. The code further causes the wireless device to initiate a discovery mode during which the wireless device parks all links having active status at least during the discovery mode and discovers another neighbor node from among the plurality of nodes for which the corresponding link is identified as having the active status. The code further causes the wireless device to activate the previously active links having parked status and then determine whether the number of links having active status is greater than a threshold value. The code further causes the wireless device to respond to a determination that the number of active links exceeds the threshold value by identifying which of the links having active status are of lowest quality and switching those identified links to parked status.

In general, in another aspect, the invention features a network including; a plurality of nodes; and a controller node, wherein each of the plurality of nodes has: a wireless transceiver for communicating with other nodes among the plurality of nodes; a memory system storing a neighbor table for recording identities of neighbor nodes among the plurality of nodes, wherein each neighbor node of the plurality of neighbor nodes has a corresponding link over which wireless communications take place, the neighbor table for also recording for each identified neighbor node an indication of whether its corresponding link has an active status or a parked status and a parameter indicating a distance of that identified neighbor node from the controller; a processor system which is programmed to respond to receiving over a link from one of the plurality neighbor nodes a message that is from the controller by sending that message out on all links that are identified as having active status except the link over which the message was received and to not send that message out on any links identified as having parked status.

In general, in still another aspect, the invention features a network including: a plurality of nodes; and a controller node, wherein each of the plurality of nodes includes: a wireless transceiver for communicating with other nodes among the plurality of nodes; a memory storing a neighbor table for recording identities of neighbor nodes among the plurality of nodes, wherein each neighbor node of the plurality of neighbor nodes has a corresponding link over which wireless communications take place, said neighbor table for also recording for each identified neighbor node an indication of whether its corresponding link has an active status or a parked status and a parameter indicating a distance of that identified neighbor node from the controller; a processor system which is programmed to respond to receiving a message that is intended for the controller by sending that message out on a subset of the links that are identified as having active status and to not send that message out on any links identified as having parked status.

Other embodiments include one or more of the following features. In each node of the plurality of nodes, the processor system of that node is further programmed to discover links to other neighbor nodes of that node and to determine whether those other discovered links are to be identified as having active status or parked status. In each node of the plurality of nodes, the neighbor table records for each node identified in the neighbor table as having a link with an active status, the table also stores a measure of the distance of that node from the controller. The measure of the distance of a node from the controller is a hop count which indicates the minimum number of nodes that a message must pass through before reaching the controller. In each node of the plurality of nodes the processor system of that node is further programmed to respond to receiving a message that is intended for the controller by sending that message out on a subset of the links that are identified as having active status and to not send that message out on any links identified as having parked status. In each node of the plurality of nodes the processor system of that node is programmed to determine the subset of the links based at least in part on how far the corresponding nodes are from the controller. In each node of the plurality of nodes the subset of the links has no more than two members.

In general, in still yet another aspect, the invention features a method implemented by a designated node that is one of a plurality of wireless nodes in a wireless network, said plurality of wireless nodes also including a controller node, the method involving comprising: storing a neighbor table in the designated node; storing a measure of a distance from the designated node and the controller node; discovering nodes among the plurality of wireless nodes that are neighbors of the designated node, each discovered neighbor node having a corresponding link for supporting communications with the discovered neighbor node; for each discovered neighbor node: sending information to the discovered node, that information including a measure of a quality of the corresponding link for that discovered neighbor node and the measure of the distance of the designated node from the controller node; receiving information from the discovered neighbor node including a measure of a quality of the corresponding link and a measure of the distance of the discovered node from the controller node; recording in the neighbor table an identifier for the discovered node and in association therewith at least some of the information received from the discovered neighbor node including the measure of the quality of the corresponding link, the measure of the distance of the discovered node from the controller node, and an indication of whether the link corresponding with that discovered node has an active status or a parked status, wherein the designated node uses links having active status to send communications and does not use links having parked status to send communications.

Other embodiments include on or more of the following features. The method also includes, for each discovered neighbor node, determining whether the discovered node is to be given a status of active or parked. For each discovered neighbor node, the determining is based on at least in part on the measure of the distance of the discovered node from the controller node. The method further includes, for each discovered neighbor node, limiting the number of links that are identified as active to a preselected number and designating the remainder of the links as parked.

The wireless system described herein can reduce installation time by up to 70 percent as compared to a wired network. Other advantages include the elimination of hazards and repair costs associated with ageing wiring and reduction in weight. Also, the network can implement several security protocols to protect the network data transmitted between nodes and is robust enough to protect critical applications.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram of a wireless data network that implements the invention.

FIG. 2 is a block diagram of the control functions.

FIG. 3 shows informant that is stored in the neighbor table.

FIG. 4 is a flow chart of the general operation of the nodes in the network of FIG. 1

FIG. 5 illustrates the discovery process.

FIG. 6 illustrates the exchange of neighbor information.

FIGS. 7A-M illustrate a scenario in which connections are formed between six network nodes.

### DETAILED DESCRIPTION

The described embodiment is an emergency lighting system that is implemented using a wireless communications network that is made up of a uniformly distributed network of identical nodes. Using embedded frequency hopping spread spectrum (FHSS) technology, e.g. Bluetooth, the nodes communicate as a network to transfer data from any wireless unit in the cabin to the aircraft's host computer and from the host compute to any other unit within the cabin while permeating only minimally outside the aircraft fuselage. The embodiment includes not only self-organization into a robust distributed network but self-healing as well.

The network is designed to operate using currently existing radio protocols and can be adapted to new wireless protocols as they become available. The network self discovers and forms a topology according to a predetermined set of rules, which controls traffic arriving from multiple paths at a receiver. Compatible nodes may be added or come on line as they are installed and powered and will automatically join the network. The network will authenticate each of the nodes that have joined and reject any that are not obeying the rules. The network allows and encourages multiples communication paths between aircraft nodes, and it continuously reforms or repair itself if any node is disabled or experiences difficulty in communicating.

What follows is a high level description of the wireless data bus designed followed by a more detailed description of the relevant algorithms.

Overview

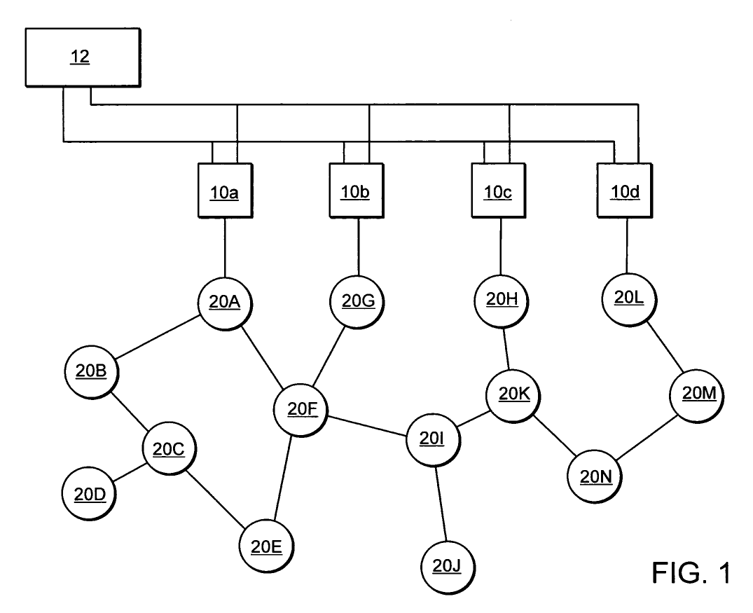

FIG. 1 is an example of a network the implements the techniques described herein. It includes a group (4) of controllers 10(a-d) each of which has a wired connection to a host computer 12 and are for the purposes of downloading configuration data, receiving commands, and returning status and fault information to the airplanes maintenance computer. The network also includes an array of nodes 20(A-N) distributed throughout the environment in which this system is deployed. In the described embodiment, which is deployed in a commercial aircraft, host computer 12 is a central control computer on the aircraft and the nodes operate all lighting in the cabin. The cabin lighting includes floor aisle lights, reading lights for the individual passengers, overhead lighting to light the cabin and emergency lighting. Controller nodes 10 communicate with nodes 20 and nodes 20 communicate with each other wirelessly using RF signaling, e.g. Bluetooth.

The nodes shown in FIG. 1 are limited in number for purposes of illustration but in reality, there is likely to be many more nodes than are shown. For example, in the described embodiment, there are up to approximately 64 distributed nodes. No more than six of these nodes have an additional control function, which includes a host system for the purpose of communication and management within the wireless network.

In this example, all controllers 10 and nodes 20 are identical devices with identical functionality, though this need not be the case. Each node includes a wireless transceiver, a processor system, memory, RAM and other hardware and interfaces necessary to implement the functionality described herein.

Any node that has a wired connection to host computer 12 is considered to be a controller. Among the set of four controllers shown in FIG. 1, one of them will be the primary or master controller which is responsible for sending messages from the network to host computer 12 and for distributing messages from host computer 12 to network nodes 20. Any one of controllers 10 can be the primary controller, the one that pays that role is either designated as such by the host computer upon initialization of the system or is selected to play that role by the group of controllers. It is, among other things, responsible for conveying status and fault information from the system to the airplane health maintenance computer.

The network relies on information from the host to define its characteristics. The host system will be able to download configuration data or code, send commands to the wireless network, and retrieve wireless network status and fault information as desired. The data will be communicated to and from remote nodes by means of messages over the wireless network.

In the described embodiment, the physical interface of the wireless base band communication is accomplished using facilities from the Bluetooth core. The Bluetooth lower stack is implemented as a COTS (commercial-off-the-shelf) part. The upper stack components are compliant to the point necessary to communicate with the lower stack.

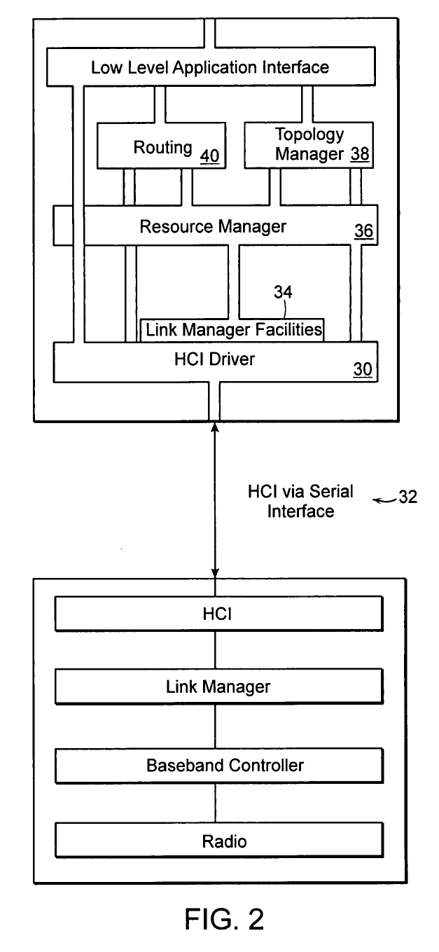

The wireless subsystem is broken down into the control functions shown in FIG. 2. They include: an HCI driver 30; an HCI driver interface 32; a link manager facility 34; a resource manager 36; a topology manager 38; and a routing function 40. Each of these control functions will now be described in greater detail.

HCI driver 30 provides an interface with the base band protocols, which represent the parts of the system that specify or implement the physical layers or medium access to support data exchange. It formats and transmits control and data packets to the base band module and receives local and remote events and buffers as needed. It is responsible for the execution of discovery sequences and flow control using message sequencing, buffer availability, and other base band resources. It handles power-on initialization, which includes the download and confirmation of patch code and the entry into normal operation. It is also responsible for the receipt of asynchronous events for which it uses a call-back function with pointers to the appropriate application based on the event received. It also manages to global watchdog timers which are implemented in all threads to prevent system level hangs.

HCI driver interface 32, which is a serial interface, maintains a buffer pointer, a call back function pointer, and various parameters (e.g. timeout, etc.). It is, as its name implies the interface enabling the link manager facilities and the resource manger to communicate with the base band manager.

Link manager facility 34 is responsible for a number of functions. It supports the link manager protocol; creates, maintains, and releases logical links; manages discovery sequences; implements park mode; implements sniff mode; provides power control; processes neighbor table; maintains link statistics; manages periodic discovery modes; manages data segmentation/reassembly; and provides an interface including a pointer to the base band controller, a pointer to a call-back function for processing message results, and other optional parameters (e.g. timeout values).

Resource manager 36 which is responsible for the following: scheduling packet transmissions and coordinating with HCI driver 30; channel mapping; frame data to be sent to the base band, fragmenting and segmenting data units into application defined packet data units (PDUs); scheduling slot use a 1a LCS (Locally Coordinated Scheduling) according to activity and message priority; message level integrity code generation and checking; executing capability security algorithm as defined; and retransmission and flow control at the message level.

Topology manager 38 is responsible for the following: piconet maintenance; role switch; scatternet operations; and discovery operations including discovering combinations of piconets and forming bridges; and bridge node identification and function.

Routing facility 40 is responsible for the following: managing downstream command/download flood; manages upstream message routing to nodes closest to controllers; and manages neighbor messages that are generated by topology manager 38.

Theory of Operation

Before the network can form, each of the constituent nodes independently initializes and becomes network ready. At node initialization, the processor resets and initializes the base band controller and verifies its presence and available features using Bluetooth low-level protocols. Each node then begins scanning for network links. This activity is known as “discovery”.

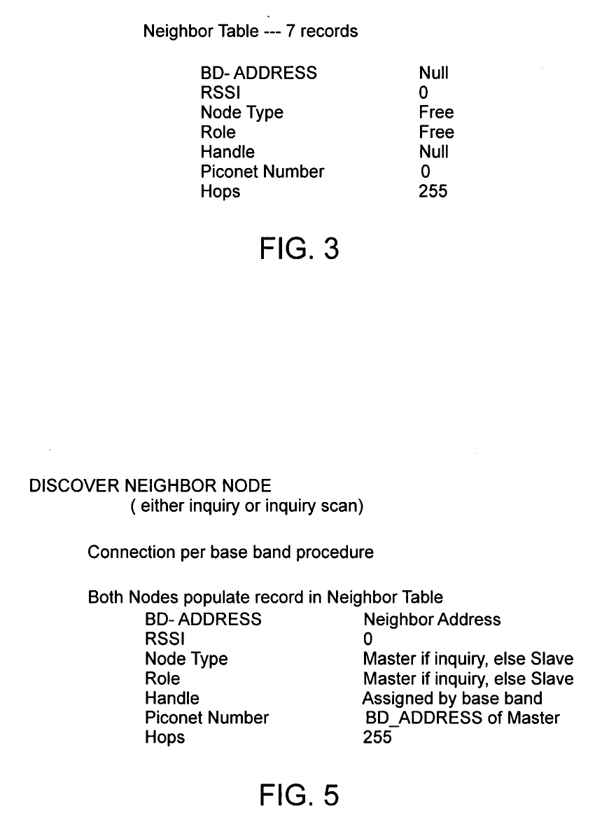

During discovery, links are formed to closest neighbors as determined by link reliability (e.g. as determined by some measure link quality such as signal strength). A local neighbor table, as illustrated in FIG. 3, is maintained that includes at least the following information about the neighbor nodes: the address of each neighbor node, the link strength (RSSI or received signal strength indication), the node type, the role of the connected node, the handle as assigned by the node when the link is formed, and the number of hops from that node to the nearest control node. The node type can be free, master, slave, and bridge. A free node has not yet been designated either a slave or a master. A bridge node is any node in the network that sees more than one master. Bridge nodes may serve as aggregation points for status being sent to the controller and provide a way for one section of the network to communicate with another section of the network.

Every node maintains a neighbor table by which it knows which neighbor nodes it has communicated with and it knows which neighbor nodes have active link handles. Connections to a neighbor node can be rejected for a number of different reasons including, for example, link quality, e.g. the RSSI is too low to produce a reliable connection, in which case that link will be parked (see below). Another reason is that the number of hops to the controller along that link exceeds a maximum threshold value, e.g. 6. This latter criterion is designed to avoid creating inefficient paths to the controllers.

Each master node also maintains a neighbor piconet table (NPT). It records the neighbor piconet as well as the local piconet which is useful from bridge nodes that facilitate communications between sections of the network.

Local (or link level) discovery proceeds according to the architecture of the physical layer. In the case of Bluetooth, each node independently and randomly enters inquiry or inquiry scan mode. In response to the inquires, the neighbors send back information such as their identifies, their hop counts, and the measured link strength (i.e., the energy of the received signal). Each node discovers neighbors within range and forms links with the nodes closest to it, which typically are the ones with highest reliability. The number of active links that are permitted in the described embodiment is limited to four. This limitation is imposed for the following reasons. First, it is designed to limit maximum connectivity in order to provide messaging in the network. Second, it makes possible establishing additional connectivity if a distressed node is discovered.

In general, the discovery and link setup rules state that first priority will be given to nodes with low or marginal connectivity and second priority will be given to the strongest links that do not provide short loops (i.e., a closed loop in the network that includes a small number of nodes). In addition, links that form short loops are broken at their weakest link. When a node discovers a link but decides not to use it as an active link, it “parks” the link. That means the node keeps information about the neighbor node in its neighbor table but it tags that neighbor node as parked, e.g. by not assigning a link handle to it. Parking neighbor nodes in this way makes it easier to initiate contact with them and activate them if one of the active links becomes inactive due to interference or some fault.

Node discovery completes when high reliability links are found to a sufficient number of neighbors. Network level discovery continues for some time until the following network criteria are met: the node discovers at least two reliable links that lead to a control node; or the node receives an end discovery message from a control node.

After discovery, a network formation algorithm is executed to create a maintainable network where redundancy is limited and resources are left available so that additional links may be added as needed. At this point, each node will have multiple links to the system control nodes and each of the control nodes will have had communication with each remote node.

The links that are setup this way are actively managed. That is, if a link breaks, the network goes into a recovery mode during which it looks for other links to replace the broken link. In fact, the network is constantly trying to heal itself by continuously trying to find better links and/or paths back to the controllers.

The system operates autonomously and is continuously available with an end-to-end command execution time of a few seconds. Therefore, once initialized and the network discovery process has been successfully executed, the nodes in the network remain in constant communication until the network is shut down or otherwise interrupted. Of importance are the formation, maintenance, reliability, and performance of the network that will convey the commands. Under normal circumstances, the host hardware will have electric power for the purpose of keeping each of the node batteries topped off. However, there may be extended periods when the main power is off.

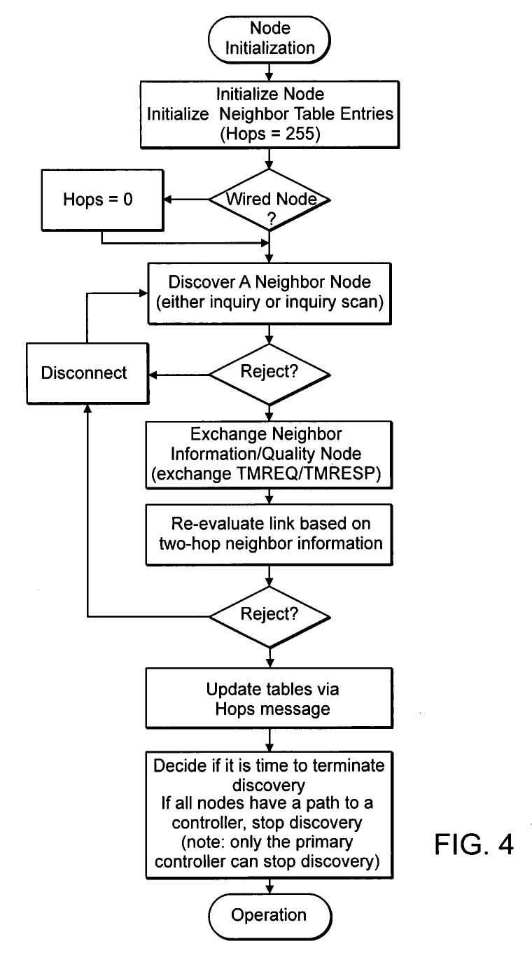

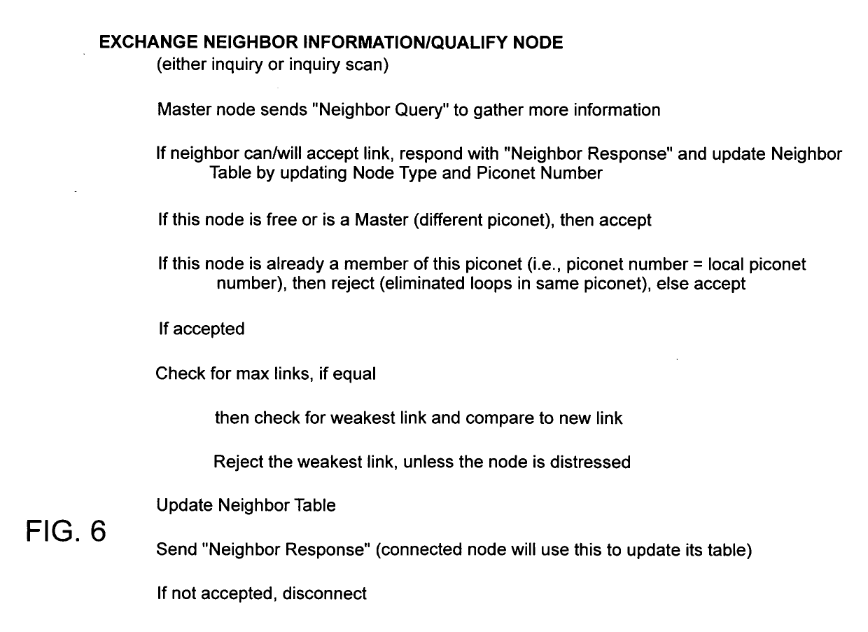

A more detailed description of the above-summarized process will not be presented with the aid of FIGS. 4-6.

After the system is powered up, each node goes through a node initialization involving: querying buffers, local features, device address; and conducting a primitive alternating inquiry and inquiry scan until the architected number of links are established.

Typically when the system is powered up, nodes will come up at different times, e.g. depending on the condition of the batteries, how fast the onboard batteries charge, etc. Some nodes will enter the inquiry mode while others will enter into the inquiry scan mode. Inquiry nodes search for other nodes and inquiry scan nodes scan for inquiry nodes. Any node that is inquiring and finds a scanning node is a master node. In the described embodiment, the system randomizes when the different nodes will become inquiry nodes or inquiry scan nodes. As a result of this process, the Bluetooth protocol will form piconets made up of master nodes and slave nodes. Once Bluetooth completes forming its networks, the nodes in the network figure out their configuration on a completely ad hoc basis.

During the initialization phase, each node initializes the values stored in its neighbor table. In the described embodiment, the neighbor table holds the records for seven neighbors as well as the local information. It sets the addresses for the neighbors to a null value, and it initializes the hop counts for all records to 255. It sets the RSSI values to 0, node type and role to free, and the piconet numbers to 0.

The node then determines whether it has a wired connection to the host computer. If it does, it sets its own hop count to zero to indicate to other nodes that it is a wired node.

After a successful initialization phase, discovery of the neighbor nodes for purposes of setting up active links commences. During discovery, an inquiring node, using the base band protocol, determines whether it can establish an active link with the other node. During the first part of this process, assuming that the connection is initially accepted, the two nodes populate the relevant parts of their neighbor tables with information about the other node. For example, they store the neighbor's address; they identify the current type and role of the other node as either a master or a slave, whichever is appropriate; and they store the piconet number of the other node (i.e., the address of the master of that piconet).

The node in that pair which is the master node sends a “Neighbor Query” message to the other node to gather more information about that node and in an effort to establish an active link. If that neighbor can accept the link and the node requesting the link satisfies other criteria (e.g. its hop count is valid but not greater than some preselected value, e.g. 6), it responds with a “Neighbor Response” message and updates the node type and piconet number in its neighbor table. The other node accepts the link if it is free (i.e., does not already have maximum number of active links) or it is a master of different piconet. If it is a member of the same piconet, it rejects the link to avoid establishing loops in the same piconet. Also note that in the described embodiment, a slave node may reject a discovery request if it has recently executed one for another master.

If the link is accepted, the node determines whether adding this new active link will result in its total number of active links exceeding the maximum number of active links that are permitted for a node (e.g. 4). If the maximum number is exceeded, the node finds the weakest link among its active links and eliminates that link. If the new link is the weakest link, the node does not accept it as a new active link. If another node is the weakest link, then the node replaces that weaker link with the new link. However, if the other node is a distressed node, (i.e., a node that is experiencing sub-nominal operation and requiring special treatment, for example a node that is isolated and with no good quality links to another node or for which the battery is running low or producing low voltage), it will accept the node even if that means its total number of active links exceeds the maximum permitted number. If the link is accepted, the node updates is neighbor table to identify it as such and its sends a “Neighbor Response” message to enable the connected node to updates its neighbor table.

Even after a neighbor node is accepted, the node will re-evaluate that decision to determine whether any loops have been formed that could lead to messages from the controller to the network circulating in a closed loop and loading down the resources of the network. In the described embodiment, the two neighbors exchange neighbor tables and check whether they share a common neighbor node. If they do share a common neighbor, they break the weakest link in the triangle of links they connect those three nodes. Of course, more complicated algorithms could be used to identify closed loops involving more than three nodes if it is necessary to improve the performance of the network further.

While the links are being established throughout the network, any node that has its hop count (or another relevant variable) change will communicate that change to all neighbors. And those neighbors will, in turn, communicate those changes to their neighbors. In this way, the nodes throughout the entire network keep up to date regarding how close they are to the edge of the network (and thus the controllers) as the network of active links is being built.

When discovery has progressed to the point at which all nodes have the requisite number of paths to one or more controllers, the primary controller sends a message stopping further discovery. Note that the primary controller makes this decision based on the status messages it receives from the nodes within the network. In the described general, the goal is to form at least two different paths back to a controller.

In the operational mode, each node will periodically re-enter discovery and communicate with any scanning node in the event that there is a node that does not have adequate connectivity. Links that are actively maintained are determined by 1) the connectivity offered as measured by the RSSI (Received Signal Strength Indication) and controller connectivity and 2) the needs of the connected node. Links not actively maintained are “parked” and an entry will be maintained in the node's neighbor table.

Upon detecting a link that has connectivity to a controller, a node will commence sending periodic status messages to the closest controller. Initial discovery terminates when: (1) a preset number of nodes has been detected by the controller; or (2) a specified timeout has expired. Both the timeout interval and the number of nodes are defined in an initial data table that is uploaded from the host system.

Thus, it should be apparent form the above description that the network will form ad-hoc according to the standard implemented physical layer, which in this case is Bluetooth V2.0. Discovery is considered complete at the node level when the node has at least two high quality connections to another node, and when the node has confirmed connectivity to at least one control node. Discovery is considered complete at the system level when the primary controller has a path to all nodes as indicated by the receipt of status messages from each node in the network. That path may include an out-of-band communication to another controller through the wired network. However, note that if the path includes an out-of-band communication link to another controller, this is considered to produce a low reliability network and error recovery procedures will be running in an attempt to correct this.

The network is designed to operate in a hostile environment, e.g. one with changing environment interference conditions that affect connectivity. In order to bring the network to a point where there is an arbitrarily high probability of connectivity, several concessions are made regarding addressing, network formation, and routing. With regard to addressing, the wireless network is headless with no centralized management or routing function; there is no end-to-end connectivity so routing is accomplished by either transmitting to or from a network; and there is no node addressability. With regard to network formation, an ad-hoc network is formed consistent with the base band protocol; the clock domains are minimized and distributed to enhance performance; short paths are eliminated to limit message re-transmission overhead; and discovery and formation continues during operation to continuously improve network distribution.

The routing that is implemented depends on the direction in which the message is sent. In the case of downstream routing (i.e., messages from the controller to the network nodes), maintenance messages or messages from the host initiate at a network edge and are flooded into the network. That is, each node that receives the message generates another like message and sends it out on all active links except the link over which the message was received. No end node address is specified.

To prevent messages from circulating endlessly (or longer than necessary) in the network thereby wasting valuable network resources, the message contains a hop count that is decremented at each node. A receiving node deletes the message and does not propagate the message if it detects hop count of zero.

In the case of upstream routing (i.e., messages send from a node to the controller or host computer), the node knows though its neighbor table all of the active links and what the distance is to the edge of the network over each of those active links and it sends the message out over two of the links representing the best path to the controllers. In other words, upstream messages are sent to the neighbor determined to have the best cost function, e.g. the neighbor closest to the network edge (e.g. a controller) as indicated by the hops to controller count. Of course, alternative cost functions can be implemented that take into account, for example, link quality and hops to controller or some other appropriate combination of measures. To deal with interference and link instability, each upstream message is transmitted on two separate links and, if a path exists, to two separate controllers.

After initial discovery is complete (e.g. 15 seconds), a continuous discovery phase begins. During the continuous discovery phase, each piconet master selects a slave in sequence to execute discovery sequences. Note that the master includes itself in the continuous discovery list. The master commands the selected slave to enter a discovery process during which it sends a message on all connected (or active) links to notify its neighbor that it will suspend (park) the link for the duration of the discovery process (e.g. 2 seconds). Then the slave enters the “Inquiry Scan” mode for about 1 second. If it detects a link, it establishes a connection. Then, it reestablishes its previous links and sends a report to the master that discovery is complete. If the number of active links at the slave is greater than a preselected threshold, maxlinks (e.g. 4), then it parks one of the links (or places it into an inactive state). To identify the link that it will park, the node finds the link with the lowest RSSI, unless that link isolates that node, in which case it will select the link to the node with the most neighbors. The slave then updates it tables and sends the updated information to all of its neighbors.

The various types of communication fault scenarios and how they are handled will now be described. One type is a node failure is due to a power failure. If the baseband or radio power is off (flat battery or circuit fault), then the processor power will be off as well and the node will be non-functional. The system recognizes that periodic status from the affected node does not occur and will send a fault message to the application. If the node processor is not functioning, communication will be interrupted and the node will be non-functional. In this case, the system again recognizes that periodic status from this node does not occur and it initiates an error recovery process.

Another source of network problems is interference, which might be intermittent or persistent. In the case of intermittent interference, connectivity can be temporarily interrupted due to internal failures (e.g. another nearby link uses the same frequency at the same time), or external failures (e.g. interference source from passenger device, microwave oven, etc.) failures. In either case, the system will retry on (hop to) a different frequency though the process will cause node or a network droop. A persistent failure is very unlikely due to the frequency hopping nature of the radio. However, if a malicious attack occurs, the node will respond as if it has a marginal signal and attempt to correct. If this occurs, the system will most likely recognize a portion of the network not functioning and will try to reestablish a connection or to recognize a system tamper and signal to the application.

Another failure scenario involves insufficient connectivity. In the described embodiment, initially every node runs at power class 3 (0 dB). If a node has some level of connectivity, its neighbors should report a minimal signal level. But the node has the ability to raise its signal level to power class 2. If this does not solve the problem, the node actively tries to discover other neighbors with better connectivity. If the node has no connectivity, it enters the discovery mode and attempts to make contact with a neighbor.

If there is an insufficient number of active links (e.g. less than four), the node initiates procedures to correct.

The wireless messages for the emergency lighting system of the described embodiment are summarized below:

Status (up) Messages
Status/Fault
Aggregated Status
Neighbor Table Upload (ELS Maintenance)
Address Assignment Acknowledge

Flood (down) Messages
Command (Primary commands)
Parametric Data (Control input and CAN data)
Address assignment
Controller topology message (routing algorithm support)
Data Table Upload
Code Upload (from network edge to all nodes)
Unformatted Transfer (Test)
Aircraft Maintenance Command (individual light outputs, etc.)

Link Messages
Neighbor query (includes neighbor service messages)
Neighbor Response (acknowledge)
Data Table Transfer (from neighbor after node reset)
RSSI Request
RSSI Response
Time Synchronization
Continuous Discovery
Hops Message

Controller-Controller Messages
Controller message—routed between controllers via wireless only
Primary Negotiation
WCU Heartbeat

Link Schedule Messages
Link Schedule negotiation packet

Most of these messages are self-explanatory. The ones deserving of particular comment because of their relevance to the way the network is formed are the following. The neighbor query/response messages, which we discussed above, are used for one node to send a neighbor table to a neighbor node and to request the neighbor to return its table. A continuous discover link command comes from a piconet master to a particular slave to initiate a discovery inquiry operation.

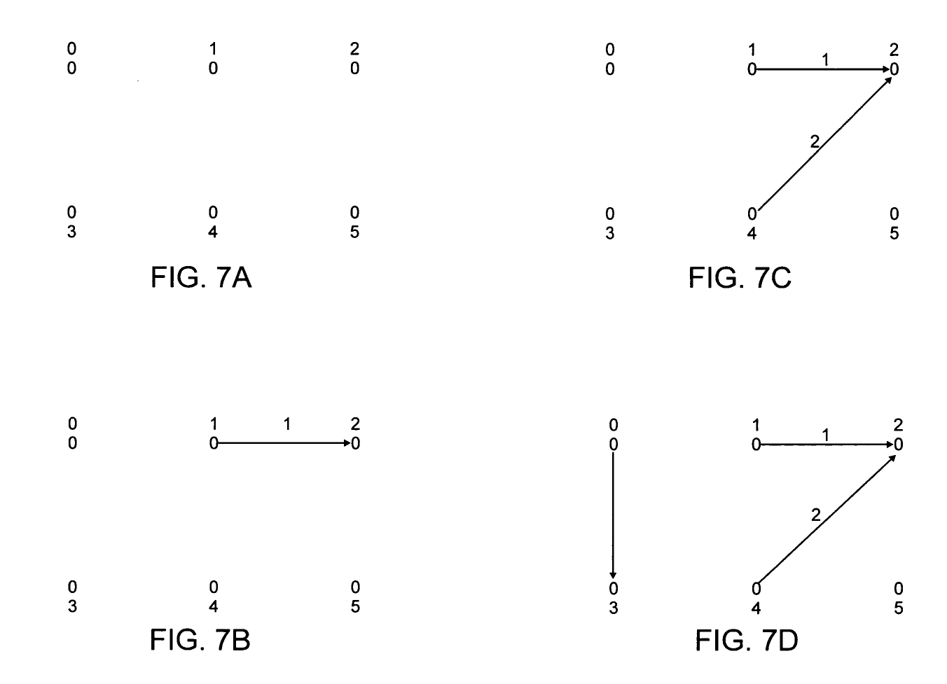

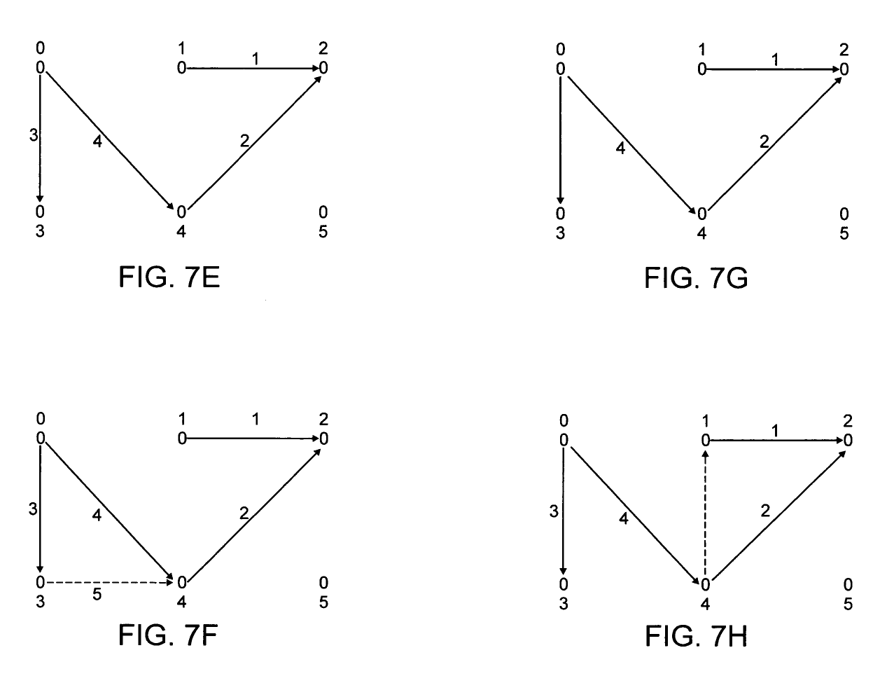

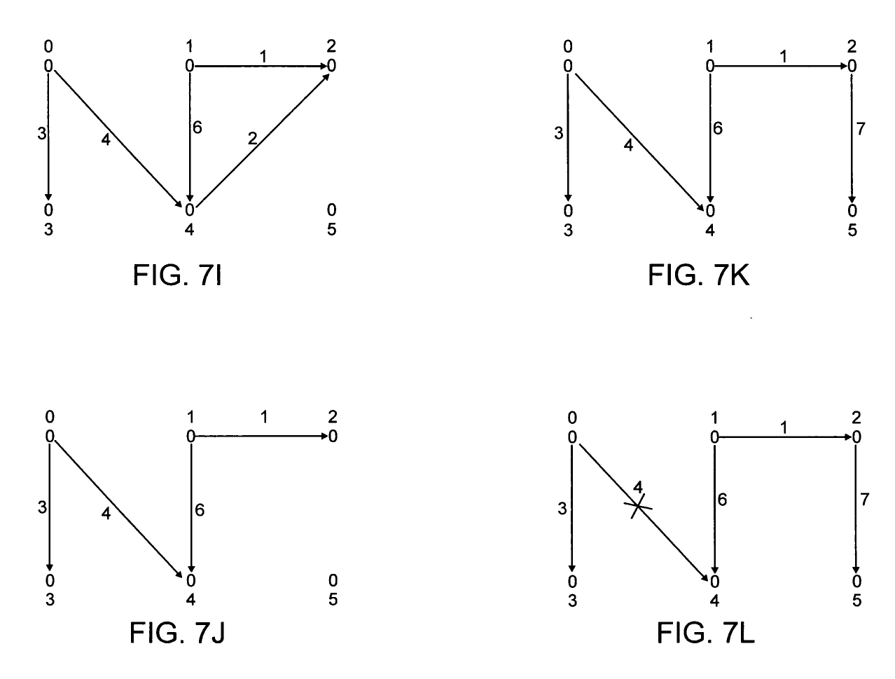

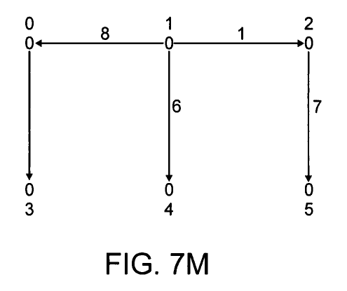

An example of a simplified system, which operates in accordance with the network forming features described above, will now be presented. In this example, the network includes six nodes as show in FIG. 7A, identified as Nodes 0-5. The discovery sequence that is described starts with Node A discovering Node 2 and each subsequent discovery attempt thereafter is random.

Referring to FIG. 7B:
Node 1 discovers node 2
Node 1 creates an entry for Node 2 in its Neighbor Table
Node 1 makes a connection to Node 2
Node 1 sends a Neighbor Query message to Node 2
Node 2 updates the entry for Node 1 in its Neighbor Table
Node 2 is FREE, so it accepts the new connection
Node 2 updates the entry for Node 1 in its Neighbor Table and updates local information such as node type piconet number
Node 2 sends back a Neighbor Response message to Node 1
Node 1 updates the entry for Node 2 in its Neighbor Table
Node 1 updates local information such as node type piconet number
Node 1 and Node 2 broadcast a Neighbor message to each other (but since nothing has changed, Nodes 1 and 2 do nothing)
   at this point none of the nodes have hops to controller counts that are less than 255, so continue

Referring to FIG. 7C
Node 4 discovers Node 2
Node 4 creates an entry for Node 2 in its Neighbor Table
Node 4 makes a connection to Node 2
Node 4 sends a Neighbor Query message to Node 2
Node 2 updates the entry for Node 4 in its Neighbor Table
for Node 2, the local piconet is not the same as Node 4's piconet, so accept Node 2 updates the entry for Node 4 in its Neighbor Table and updates local information such as node type identified as a bridge
Node 2 reports new connection to Node 1, registering as a bridge
Node 1 updates NPT (neighbor piconet table)
Node 2 sends back a Neighbor Response message to Node 4
Node 4 updates the entry for Node 2 in its Neighbor Table
Node 4 updates local information such as node type=Master and piconet=4
Node 4 registers Node 2 as a bridge, updates the NPT
Node 2 and Node 4 broadcast a Neighbor message to each other (but Nodes 2 and 4 do not have common neighbors, so do nothing) (since hops to controller has not changed, Nodes 2 and 4 do not broadcast hops message)
none of the nodes have hop counts that are less than 255, so continue

Referring to FIG. 7D:
Node 0 discovers Node 3
Node 0 creates an entry for Node 3 in its Neighbor Table
Node 0 makes a connection to Node 3
Node 0 sends a Neighbor Query message to Node 3
Node 3 updates the entry for Node 0 in its Neighbor Table
Node 3 is FREE, so it accepts the new connection
Node 3 updates the entry for Node 0 in its Neighbor Table
Node 3 updates hops to controller=1
Node 3 sets next_hop to Node 0
Node 3 sends back a Neighbor Response message to Node 0
Node 0 updates the entry for Node 3 in its Neighbor Table
Node 0 marks Node 3 as the previous_hop in its Neighbor Table
Node 0 updates local information e.g. node type=Master and piconet=0
Node 0 and Node 3 broadcast a Neighbor message to each other (but since nothing has changed, Nodes 0 and 3 do nothing)
Node 3 broadcast hop message top Node 0 (since its hops to controller has changed) (Node 0 receives the hop count but updates nothing) since only Nodes 0 and 3 have hops to controller<255, continue

Referring to FIG. 7E:
Node 0 discovers Node 4
Node 0 creates an entry for Node 4 in its Neighbor Table
Node 0 makes a connection to Node 4
Node 0 sends a Neighbor Query message to Node 4
Node 4 updates the entry for Node 0 in its Neighbor Table
Node 4 is a Master node, so it accepts
Node 4 updates the entry for Node 0 in its Neighbor Table and updates local information, e.g. node type=Bridge and piconet=4
Node 4 updates its hops to controller count and next_hop=Node 0
Node 4 is a ridge, so updates NPT
Node 4 sends back a Neighbor Response message to Node 0
Node 0 receives message and updates the entry for Node 4 in its Neighbor Table
Node 0 updates local hops to controller=0
Node 0 updates local node type=Master and local piconet=0
Node 0 updates NPT
Node 0 and Node 4 send their NT to each other
Nodes 0 and 4 do not have neighbors in common, so do nothing
since Node 4 hops to controller has changed from 255 to 1, Node 4 broadcasts hops message to Nodes 0 and 2
Node 0 does nothing since its hops to controller is less than the reported hops to controller+1
Node 2 selects the minimal valid hops to controller count in its Neighbor Table (H=1)
Node 2 updates local hops to controller=(H+1)=2
Node 2 updates next_hop=Node 4
Since its hops to controller changed, Node 2 broadcast hops message to Nodes 1 and 4
Node 4 receives hop message from Node 2 and marks Node 2 as previous hop
Node 1 receives hop message from Node 2 and updates its Neighbor Table
Node 1 updates local hops to controller to 3
Node 1 selects the minimal hops to controller in its Neighbor Table (H=2)
Node 1 updates local hops to controller=3
Node 1 updates next_hop=Node 2
Node 1 broadcasts hop message to Node 2
Node 2 receives hop message from Node 1 and marks Node 1 as previous hop for Node 5 hops to controller=255, so continue discovery

Referring to FIGS. 7F and 7G:
Node 3 receives an inquiry response from Node 4
Node 3 creates a new entry form Node 4 in its Neighbor Table
Node 3 makes a physical connection to Node 4
Node 3 sends a Neighbor Query message to Node 4
Node 4 updates its Neighbor Table
Since Nodes 3 and 4 are in the same piconet, Node 4 rejects new link
Node 4 disconnects

Referring to FIGS. 7H, 7I and 7J:
Node 4 receives an inquiry response from Node 1
Node 4 creates a new entry for Node 1 in its Neighbor Table
Node 4 makes a physical connection to Node 1
Node 4 sends a Neighbor Query message to Node 1
Node 1 updates its Neighbor Table
Node 1 is a master and Node 4 is a bridge, switch roles
Node 1 sends a message Query to Node 4
Node 4 updates its Neighbor Table based on the received Neighbor Query message
Node 4 accepts the connection
Node 4 updates its Neighbor Table and its local information, e.g. node type=bridge
Node 4 updates NPT
Node 4 send Neighbor Response message to Node 1
Node 1 receives the Neighbor Response message and updates its Neighbor Table
Node 1 updates local hops to controller=2
Node 1 sets next_hop=Node 4
Node 1 updates other local information, e.g. node type=master, piconet=1
Node 1 updates NPT
Nodes 1 and 4 send Neighbor messages to each other
Nodes 1 and 4 have the same connected neighbor (i.e., Node 2), so select the weakest (which is the link from Node 4 to Node 2)
Node 4 is responsible for disconnecting link to Node 2 and updates its Neighbor Table and other local information, e.g. Nodes 2 and 4 register each other as not connected; Node 2 becomes a slave, piconet=1, and hops to controller=255
For Node 1, hops to controller changed, so broadcasts hops message to Nodes 2 and
Node 2 updates its Neighbor Table based on the received hops message
Node 2 recalculates hops to controller (=3) and updates next_hop (=Node 1)
Node 4 receives the hops message from Node 1, nothing updated
Node 2 broadcast hops message to Node 1
Node 1 receives hops message from Node 2 and updates its Neighbor Table
for Node, 5 hops to controller=255, so continue discovery

Referring to FIG. 7K:
Node 2 receives inquiry response from Node 5
Node 2 creates Neighbor Table entry for Node 5
Node 2 makes physical connection to Node 5
Node 2 sends Neighbor Query message to Node 5
Node 5 creates an entry in its Neighbor Table for Node 2
Node 5 is FREE, so accept
Node 5 updates its Neighbor Table and local information, e.g. node type=slave and piconet=2
Node 5 updates local hops to controller from 255 to 4
Node 5 send a Neighbor Response message to Node 2
Node 2 receives Neighbor Response message and updates its Neighbor Table
Node 2 updates local information, e.g. node type=bridge and piconet=1 and 2
Node 2 is a bridge, so report to Node 1, registering Node 2 as a bridge
Node 1 updates NPT
Nodes 2 and 5 send Neighbor Tables to each other (they do nothing in response to receiving Neighbor Tables)
Node 5 since local hops to controller is changed broadcast hops message to Node 2
Node 2 receives message but does nothing since its Neighbor Table is up to date since all nodes have hops to controller counts that are less than 255, stop discovery

Referring to FIG. 7L:
Link from Node 0 to Node 4 breaks
Node 0 updates its Neighbor Table
Node 4 updates its Neighbor Table
Node 4 recalculates local information (hops to controller=255)
Node 4 broadcasts hop message to Node 1
Node 1 receives hop message and updates its Neighbor Table
Node 1 selects the minimum hops to controller among connected neighbors (no entry selected since they are all 255)
Node 1 updates local hops to controller=255
Node 1 updates next-hop (=−1)
local information is changed, so Node 1 broadcasts hops message to Nodes 2 and 4
Node 4 receives hops message, but nothing is updated
Node 2 receives hops message and updates its Neighbor Table
Node 2 selects the minimum hops to controller among connected neighbors (no entry selected since they are all 255)
Node 2 updates local hops to controller=255
Node 2 updates next-hop (=−1)
local information is changed, so Node 2 broadcasts hops message to Nodes 1 and 5
Node 1 receives message, but nothing is changed
Node 5 receives hops message and updates its Neighbor Table
Node 5 recalculates local information, e.g. hops to controller=next hop=−1
local information is changed, so Node 5 broadcast hops message to Node 2
Node 2 receives message, but nothing is updated

Referring to FIG. 7M:
New connection from Node 1 to Node 0 is created
Node 1 sends Neighbor Query message to Node 0
Node 0 receives Neighbor Query message
Node 0 accepts the new connection
Node 0 updates the entry of 4 in its Neighbor Table and updates local information, e.g. node type=bridge, piconet=0 and 1
Node 0 updates NPT
Node 0 sends back Neighbor Response message to Node 1
Node 1 receives message and updates its Neighbor Table
Node 1 updates local hops to controller=1
Node 1 updates next_hop=Node 0
Node 1 updates local information, e.g. node type=Master, piconet=1
Nodes 1 and 4 update NPT
Node 0 and Node 1 exchange Neighbor Tables
Node 1 broadcasts hops message to Nodes 0, 2, and 4
Node 0 updates its Neighbor Table
Node 2 updates its Neighbor Table
Node 4 updates its Neighbor Table
Node 2 updates local hops to controller=2
Node 4 updates local hops to controller=2
Node 2 updates next_hop=Node 1
Node 4 updates next_hop=Node 1
Node 2 broadcast hops message to nodes 1 and 5
Node 4 broadcast hops message to Node 1
Node 1 receives hops message from Nodes 2 and 4 and updates its Neighbor Table
Node 5 receives hops message from Node 2 and updates its Neighbor Table
Node 5 updates its hops to controller=3
Node 5 updates next_hop=Node 2
Node 5 broadcasts hops message to Node 2
Node 2 receives hops message and updates its Neighbor Table
Stop Discovery

It should be noted that the described embodiment used the Bluetooth technology. However, other wireless protocols either currently available or which become available at some future date could be employed to accomplish the functionality described herein.

Also, it should be noted that the tables mentioned above are ways of conceptualizing the structure of data stored in the nodes, such as within a memory (e.g., RAM), and the actual physical representation and orientation of such stored data needs not assume a tabular form.

Finally, it should further be noted that all of the processes and algorithms described herein are to be associated with the appropriate physical quantities and are merely convenient labels applied to these quantities. Unless specifically stated otherwise, it should also be understood that throughout this description, discussions utilizing terms such as “processing” or “computing” or “calculating” or “determining” or the like, refer to the actions and processes of a computer system or processing element or similar electronic computing device, that manipulates and transforms data represented as physical (electronic) quantities within the computer system's registers and memories into other data similarly represented as physical quantities within the computer system memories or registers or other such information storage, transmission or display devices.

Though the described embodiment is deployed in an aircraft for controlling emergency and other lighting, it should be understood that there are may other environments in which this technology can be deployed and other uses to which it can be put. In general, the technology can be used to provide a wireless data bus for caring whatever data is appropriate for the particular application. It is particularly useful in environments in which there are substantial signal obstructions that vary in unpredictable ways.

Other embodiments are within the following claims.

What is claimed is:

1. A wireless device for use with a plurality of wireless nodes that includes a controller node, said wireless device comprising:
a wireless transceiver for wirelessly communicating with the plurality of wireless nodes;
a processor system; and
memory storing a neighbor table, said memory also storing code which when executed on the processor causes the wireless device to initiate a discovery process during which the wireless device discovers neighbor nodes with which the wireless device establishes wireless communication links, identifies the discovered neighbor nodes in the neighbor table, and for each identified neighbor in the neighbor table indicates whether the corresponding link has an active status or a parked status, wherein the wireless device uses links having active status to send communications and does not use links having parked status to send communications.

2. The wireless device of claim 1, wherein the memory stores a measure of a distance that the wireless device is from the controller and wherein the code further causes the wireless device to send to each discovered neighbor node with which the wireless device establishes a wireless communications link information from its neighbor table as well as the measure of the distance of the wireless device from the controller, an identity of the wireless device, and a measure of the quality of the communications link with that discovered neighbor node.

3. The wireless device of claim 1, wherein the code further causes the wireless device to receive information from the discovered neighbor nodes and store that received information in the neighbor table in association with the corresponding identified discovered nodes.

4. The wireless device of claim 1, wherein the code further causes the wireless device to determine for which discovered neighbor nodes the corresponding links are to be identified as having active status and for which the corresponding links are to be identified as having parked status based at least in part on which discovered neighbor nodes provide better paths to the controller node.

5. The wireless device of claim 1, wherein the code further causes the wireless device to determine for which discovered neighbor nodes the corresponding links are to be identified as having active status and for which the corresponding links are to be identified as having parked status based at least in part on how far the discovered nodes are from the controller.

6. The wireless device of claim 1, wherein the code further causes the wireless device to determine for which discovered neighbor nodes the corresponding links are to be identified as having active status and for which the corresponding links are to be identified as having parked status based at least in part on the strength of signals received over the communications links to the discovered nodes.

7. The wireless device of claim 1, wherein the code further causes the wireless device to initiate a discovery mode during which the wireless device parks all links having active status at least during the discovery mode and discovers another neighbor node from among the plurality of nodes for which the corresponding link is identified as having the active status.

8. The wireless device of claim 7, wherein the code further causes the wireless device to activate the previously active links having parked status and then determine whether the number of links having active status is greater than a threshold value.

9. The wireless device of claim 8, wherein the code further causes the wireless device to respond to a determination that the number of active links exceeds the threshold value by identifying which of the links having active status are of lowest quality and switching those identified links to parked status.

10. A network comprising:
a plurality of nodes; and
a controller node,
wherein each of the plurality of nodes comprises:
a wireless transceiver for communicating with other nodes among the plurality of nodes;
a memory system storing a neighbor table for recording identities of neighbor nodes among the plurality of nodes, wherein each neighbor node of the plurality of neighbor nodes has a corresponding link over which wireless communications take place, said neighbor table for also recording for each identified neighbor node an indication of whether its corresponding link has an active status or a parked status and a parameter indicating a distance of that identified neighbor node from the controller; and
a processor system which is programmed to respond to receiving over a link from one of the plurality neighbor nodes a message that is from the controller by sending that message out on all links that are identified as having active status except the link over which the message was received and to not send that message out on any links identified as having parked status.

11. The network of claim 10, wherein in each node of the plurality of nodes the processor system of that node is further programmed to discover links to other neighbor nodes of that node and to determine whether those other discovered links are to be identified as having active status or parked status.

12. The network of claim 10, wherein in each node of the plurality of nodes, the neighbor table records for each node identified in the neighbor table as having a link with an active status, the table also stores a measure of the distance of that node from the controller.

13. The network of claim 10, wherein the measure of the distance of a node from the controller is a hop count which indicates the minimum number of nodes that a message must pass through before reaching the controller.

14. The network of claim 10, wherein in each node of the plurality of nodes the processor system of that node is further programmed to respond to receiving a message that is intended for the controller by sending that message out on a subset of the links that are identified as having active status and to not send that message out on any links identified as having parked status.

15. The network of claim 10, wherein in each node of the plurality of nodes the processor system of that node is programmed to determine the subset of the links based at least in part on how far the corresponding nodes are from the controller.

16. The network of claim 10, wherein in each node of the plurality of nodes the subset of the links has no more than two members.

17. A network comprising:
a plurality of nodes; and
a controller node,
wherein each of the plurality of nodes comprises:
a wireless transceiver for communicating with other nodes among the plurality of nodes;
a memory storing a neighbor table for recording identities of neighbor nodes among the plurality of nodes, wherein each neighbor node of the plurality of neighbor nodes has a corresponding link over which wireless communications take place, said neighbor table for also recording for each identified neighbor node an indication of whether its corresponding link has an active status or a parked status and a parameter indicating a distance of that identified neighbor node from the controller; and
a processor system which is programmed to respond to receiving a message that is intended for the controller by sending that message out on a subset of the links that are identified as having active status and to not send that message out on any links identified as having parked status.

18. The network of claim 17, wherein in each node of the plurality of nodes the processor system of that node is further programmed to discover links to other neighbor nodes of that node and to determine whether those other discovered links are to be identified as having active status or parked status.

19. The network of claim 17, wherein in each node of the plurality of nodes, the neighbor table records for each node identified in the neighbor table as having a link with an active status, the table also stores a measure of the distance of that node from the controller.

20. The network of claim 17, wherein the measure of the distance of a node from the controller is a hop count which indicates the minimum number of nodes that a message must pass through before reaching the controller.

21. A method implemented by a designated node that is one of a plurality of wireless nodes in a wireless network, said plurality of wireless nodes also including a controller node, said method comprising:
storing a neighbor table in the designated node;
storing a measure of a distance from the designated node and the controller node;
discovering nodes among the plurality of wireless nodes that are neighbors of the designated node, each discovered neighbor node having a corresponding link for supporting communications with the discovered neighbor node;
for each discovered neighbor node:
sending information to the discovered node, said information including a measure of a quality of the corresponding link for that discovered neighbor node and the measure of the distance of the designated node from the controller node;
receiving information from the discovered neighbor node including a measure of a quality of the corresponding link and a measure of the distance of the discovered node from the controller node;
recording in the neighbor table an identifier for the discovered node and in association therewith at least some of the information received from the discovered neighbor node including the measure of the quality of the corresponding link, the measure of the distance of the discovered node from the controller node, and an indication of whether the link corresponding with that discovered node has an active status or a parked status, wherein the designated node uses links having active status to send communications and does not use links having parked status to send communications.

22. The method of claim 21, further comprising, for each discovered neighbor node, determining whether the discovered node is to be given a status of active or parked.

23. The method of claim 22, wherein, for each discovered neighbor node, the determining is based on at least in part on the measure of the distance of the discovered node from the controller node.

24. The method of claim 22, further comprising, for each discovered neighbor node, limiting the number of links that are identified as active to a preselected number and designating the remainder of the links as parked.
